(19) United States
(12) Patent Application Publication
(10) Pub. No.: US 2004/0013923 A1
(43) Pub. Date: Jan. 22, 2004

(54) System for storing and recoving energy and method for use thereof

(76) Inventors: Trent Molter, Glastonbury, CT (US); Larry Moulthrop, Windsor, CT (US); John Speranza, West Hartford, CT (US); William Smith, Suffield, CT (US)

Correspondence Address: CANTOR COLBURN, LLP, 55 GRIFFIN ROAD SOUTH, BLOOMFIELD, CT, 06002

(21) Appl. No.: 10/369,241

(22) Filed: Feb. 19, 2003

Related U.S. Application Data
(60) Provisional application No. 60/358,478, filed on Feb. 19, 2002.

(51) Int. Cl. H01M 8/04; H01M 8/06

(52) U.S. Cl. 429/25; 429/19; 429/21; 429/17

(57) ABSTRACT

An energy storage and recovery system includes a renewable power source, a hydrogen generation device in electrical communication with the renewable power source, a hydrogen storage device in fluid communication with the hydrogen generation device, a hydrogen fueled electricity generator in fluid communication with the hydrogen storage device, and a pressure regulator interposed between and in fluid communication with the hydrogen fueled electricity generator and the hydrogen storage device. The pressure regulator is set at an operating pressure of the hydrogen fueled electricity generator.

### CROSS REFERENCE TO RELATED APPLICATIONS

This application claims the benefit of U.S. Provisional Application Ser. No. 60/358,478, filed Feb. 19, 2002, which is incorporated by reference in its entirety.

### BACKGROUND

This disclosure relates generally to electrochemical cell systems, and especially relates to the storage and recovery of energy from a renewable power source.

Geographically remote areas such as islands or mountainous regions are often not connected to main utility electrical grids due to the cost of installing and maintaining the necessary transmission lines to carry the electricity. Even in remote communities where the transmission lines are in place, it is not uncommon for frequent and extended power outages due to weather related faults. In either case, to prevent economic loss in times of an electrical outage, it is often necessary for these communities or industries in these regions to create local “micro” electrical grids to ensure a reliable and uninterruptible power system. This uninterruptible power system may be either a primary system where there is no connection to the main utility grid, or a backup system that activates when an outage occurs.

Electrical power for the local grids comes from a variety of sources including hydrocarbon based and renewable power sources. Within a particular grid it is not uncommon to have multiple generation sources, such as diesel generators, natural gas generators, photovoltaic arrays, hydro turbines, and/or wind turbines working in combination to meet the needs of the grid.

Electrical demands placed on the local grid will vary during the course of a day, week, or season. Since it is not often practical or possible to turn generation sources on and off, inevitably excess energy will be created. This excess energy is typically converted into another form of energy such as heat for storage in another medium such as water. In cold climates, the heated water can then be used for other purposes such as heating buildings, cooking or maintaining temperature in equipment. As the load requirements of the grid increase, it is difficult or impossible to recapture the converted energy back into electrical energy for use in the electrical grid. Further complicating matters is that renewable power sources do not typically run continuously at full power and will experience extended periods of low to no energy output (e.g., night time or seasonal low wind periods).

What is needed in the art is a regenerative system for storing and recovering energy created by a renewable power source for later use in an electrical grid and a method for use thereof.

### BRIEF SUMMARY

Disclosed herein are energy storage and recovery systems and methods for use thereof. An exemplary embodiment of an energy storage and recovery system comprises An energy storage and recovery system includes a renewable power source, a hydrogen generation device in electrical communication with the renewable power source, a hydrogen storage device in fluid communication with the hydrogen generation device, a hydrogen fueled electricity generator in fluid communication with the hydrogen storage device, and a pressure regulator interposed between and in fluid communication with the hydrogen fueled electricity generator and the hydrogen storage device. The pressure regulator is set at an operating pressure of the hydrogen fueled electricity generator.

In another embodiment, an energy storage and recovery system includes a renewable power source, a regenerative electrochemical cell system having an electrolysis module and a fuel cell module, a hydrogen storage device in fluid communication with the electrolysis module and the fuel cell module, a first pressure regulator disposed between the hydrogen storage device and the electrolysis module, a second pressure regulator disposed between the fuel cell module and the hydrogen storage device, and a power conditioner interposed between and in electrical communication with the renewable power source and the regenerative electrochemical cell system. The first pressure regulator is set at a pressure greater than the pressure that the second pressure regulator is set at.

An embodiment for operating an energy storage and recovery system includes generating and conditioning electrical power from a renewable power source, powering an electrochemical cell system with the conditioned electrical power and water to electrolytically produce hydrogen gas, drying the hydrogen gas in a dryer to remove water, storing the hydrogen gas at a first pressure, and supplying the hydrogen gas at a second pressure to a hydrogen fueled electricity generator to produce electrical power in response to the electrical power generated by the renewable power source being less than or equal to a selected level. The hydrogen gas supplied to the hydrogen fueled electricity generator flows through the dryer and absorbs water prior to flowing into the hydrogen fueled electricity generator. The second pressure is less than the first pressure.

An embodiment for operating a regenerative electrochemical cell system includes introducing water and power to an electrolysis module to produce hydrogen and oxygen, directing the hydrogen through a phase separation device and a dryer, thereby producing dry hydrogen, to a hydrogen storage device at a pressure, hydrating the dry hydrogen by reducing the pressure of the dry hydrogen from the hydrogen storage device and, passing the dry hydrogen through the dryer thereby transferring water from the dryer to the dry hydrogen to form a hydrated hydrogen, fueling a fuel cell by directing the hydrated hydrogen to the fuel cell module, introducing oxygen to the fuel cell module, and producing electricity and water at the fuel cell module.

An embodiment for producing power includes generating power from a renewable power source, conditioning the power for use in an electrochemical cell system, maintaining water at a temperature above a freezing point of water, forming hydrogen gas from the water using the conditioned power, recovering water from an oxygen water stream, venting oxygen to the environment, drying the hydrogen gas, compressing the hydrogen gas, storing the hydrogen gas at a pressure of greater than or equal to about 1,000 psi, monitoring availability of the renewable power source, reducing the pressure of the hydrogen gas, introducing a portion of the reduced pressure hydrogen gas to an internal combustion engine in response to the availability of the renewable power source being less than or equal to a first selected level, generating power using the internal combustion engine, introducing another portion of the hydrogen gas to a fuel cell in response to the availability of the renewable power source being less than or equal to a second selected level, generating power using the fuel cell, and operating power support systems using grid power.

The above discussed and other features will be appreciated and understood by those skilled in the art from the following detailed description and drawings.

### BRIEF DESCRIPTION OF THE DRAWINGS

Referring now to the drawings, which are meant to be exemplary and not limiting, and wherein like elements are numbered alike:

FIG. 1 is a schematic diagram illustrating a prior art electrochemical cell;

FIG. 2 is a schematic diagram representing a local electrical grid having an energy storage and recovery system;

FIG. 3 is a schematic diagram representing a local electrical grid having a regenerative electrochemical cell system;

FIG. 4 is a schematic diagram representing a regenerative electrochemical cell system; and

FIG. 5 is a schematic diagram representing another regenerative electrochemical cell system.

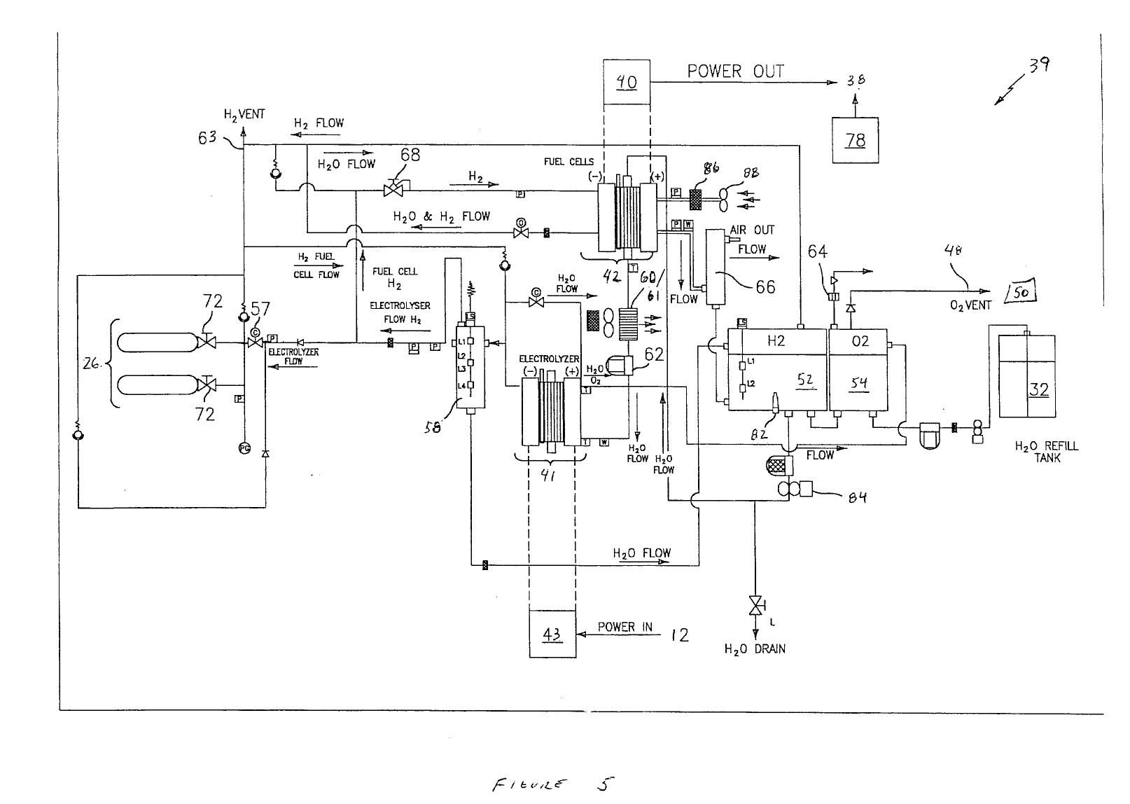

### DETAILED DECRIPTION OF THE PREFERRED EMBODIMENTS

Generally, the device disclosed herein, in one embodiment, can comprise a renewable power source 12, a hydrogen generation device 22, a hydrogen storage device 26 and a hydrogen fueled electricity generator 31.

Another embodiment of the energy storage and recovery system comprises a hydrogen generator 18 in fluid communication with a storage device 26 that is in fluid communication with a hydrogen fueled electricity generator 31 such as a fuel cell 34 or internal combustion generator set 35 (i.e., genset). The internal combustion genset 35 comprises a hydrogen fueled internal combustion engine coupled with a generator.

Another embodiment of the energy storage and recovery system comprises a renewable power source 12, a regenerative electrochemical cell system 39 (also referred herein as the regen-system, and the regenerative energy system) having a power conditioner 40, an electrolysis module 41, and a fuel cell module 42. The regenerative electrochemical device 39 is further in fluid communication with a hydrogen storage device 26.

Another embodiment of the regenerative electrochemical cell system 39 includes a fuel cell module 42 comprising a fuel cell oxygen inlet 90 in fluid communication with a water storage device 52, 54, and a fuel cell hydrogen inlet 92 in fluid communication with both an oxygen source 54 and a gaseous portion of a water phase separation device 58; an electrolysis module 41 comprising an electrolysis water inlet 94 in fluid communication with the water storage device 52, 54 via a fuel cell oxygen outlet 96, and an electrolysis water outlet 98 in fluid communication with the fuel cell hydrogen inlet 92.

Another embodiment of the electrochemical regenerative cell system 39 includes a first conduit 130 in fluid communication with a hydrogen storage device 26 and a dryer 56; a first pressure regulator 59 disposed in the first conduit 130 between the hydrogen storage device 26 and the dryer 56, the pressure regulator 59 being effective to reduce a pressure of a gas stream discharged from the storage device 26 into the dryer apparatus 56, e.g., during a purging process, to remove moisture from the dryer 56; a second conduit 132 in fluid communication with the fuel cell module 42, at least one of the hydrogen storage device 26 and the dryer 56; and a second pressure regulator 68 disposed in the second conduit 132, wherein a pressure rating for the first pressure regulator is preferably equal to or greater than a pressure rating for the second pressure regulator.

One embodiment for operating an energy storage and recovery system includes generating electrical power from a renewable power source 12; powering a hydrogen generation device 18 with the electrical power; storing the hydrogen; and supplying the hydrogen to a hydrogen fueled electricity generator 31.

One embodiment for operating a regenerative electrochemical cell system 39, includes introducing feed hydrogen from a hydrogen storage system 26 to a fuel cell hydrogen electrode (cathode) 114 and introducing a first source of oxygen from an oxygen/water phase separation device 66 to a fuel cell oxygen electrode (anode) 116; reacting hydrogen ions with the oxygen to generate electricity and water; ceasing the introduction of the first source of oxygen from the oxygen/water phase separation device once the fuel cell has attained operating conditions, and introducing a second source of oxygen from a surrounding atmosphere module 50 to the fuel cell oxygen electrode 116; directing the water to a water storage device 52, 54; introducing the water to an electrolysis water electrode, via water inlet 94; introducing power to an electrolysis module, via power conditioner 43, to produce refuel hydrogen and oxygen; and directing the refuel hydrogen to the hydrogen storage device 26.

Another embodiment for a method for operating a regenerative electrochemical cell system 39, which may be used alone or in combination with other methods, includes maintaining a fuel cell 42 in a ready condition such that the fuel cell 42 attains an operating temperature in less than or equal to about 1 minute; introducing hydrogen to a fuel cell hydrogen electrode 114 and oxygen to a fuel cell oxygen electrode 116; forming hydrogen ions and electrons at the fuel cell hydrogen electrodes 114; passing the electrons through a load to the fuel cell oxygen electrode 116; and reacting the hydrogen ions with the oxygen at the fuel cell oxygen electrode 116 to form water.

Yet another embodiment for a method for operating a regenerative electrochemical cell system 39, which may be used alone or in combination with other methods, includes introducing feed hydrogen from a hydrogen storage device 26 to a fuel cell hydrogen electrode 114 and introducing feed oxygen to a fuel cell oxygen electrode 116; reacting hydrogen ions with the oxygen to generate electricity and water; introducing an oxygen/water stream from the fuel cell oxygen electrode 116 through a vortex tube 134 to produce a hot stream and a cool stream; and introducing the cool stream to a phase separation device 66.

A further embodiment for a method for operating a regenerative electrochemical cell system 39, which may be used alone or in combination with other methods, includes introducing water and power to an electrolysis module 41 to produce refuel hydrogen and oxygen; directing the refuel hydrogen through a hydrogen storage system having a hydrogen/water phase separation device 58 and an inverted hydrogen storage device 26, wherein the refuel hydrogen passes from the electrolysis module 41 through the hydrogen/water phase separation device 58 past a shut off valve 57, and into the inverted hydrogen storage device 26; hydrating and fueling a fuel cell module 42 by directing the refuel hydrogen from the inverted hydrogen storage device 26, and water through the hydrogen/water phase separation device 58, to the fuel cell modulee 42; introducing oxygen to the fuel cell module 42; and producing water and electricity from the fuel cell module 42.

Another embodiment for a method for operating a regenerative electrochemical cell system 39, which may be used alone or in combination with other methods, includes introducing water and power to an electrolysis module 41 to produce refuel hydrogen and oxygen; directing the refuel hydrogen through a hydrogen/water phase separation device 58 and a dryer 56 into a hydrogen storage device 26 at a pressure, wherein the dryer 56 removes water from the refuel hydrogen to form a dry hydrogen; hydrating and fueling a fuel cell module 42 by reducing the pressure of the dry hydrogen to a reduced pressure; passing the dry hydrogen through the dryer 56; removing water from the dryer 56 to form a hydrated hydrogen; directing the hydrated hydrogen to a fuel cell hydrogen electrode 114 of a fuel cell module 42; introducing oxygen to a fuel cell oxygen electrode 116; and producing water and electricity.

An even further embodiment for a method for operating a regenerative electrochemical cell system 39, which may be used alone or in combination with other methods, includes maintaining a fuel cell 42 in a stand-by condition such that the fuel cell 42 attains an operating temperature in less than or equal to about 1 minute; introducing hydrogen and oxygen to the fuel cell 42 to form water and electricity.

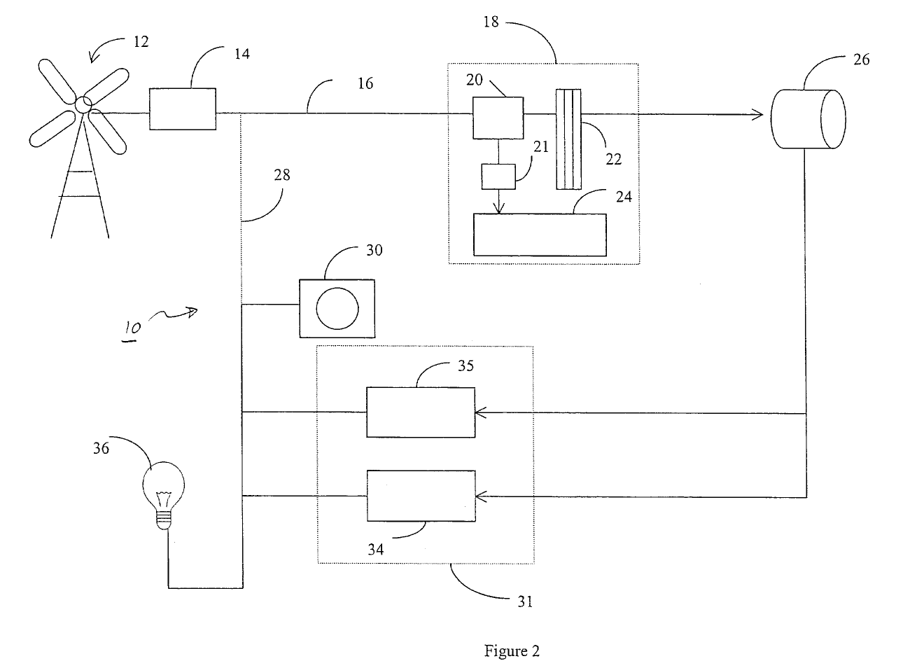

A regenerative energy system described herein and depicted in FIG. 2 includes an electrolysis module 18, a hydrogen storage device 26, and a hydrogen fueled electricity generator 31. This regenerative energy system can maintain a primary or uninterrupted power supply to numerous applications, including residential and commercial. Some possible commercial applications include the telecommunications industry (e.g., outside plants, cell towers, semiconductor manufacturing facilities, data centers, and the like), computers (e.g., individual computers, networks of computers, and the like), individual businesses, office parks, cables (e.g., telephone, internet, and the like), power grids, and the like, as well as combinations comprising at least one of the foregoing applications. Some possible residential uses include individual homes, neighborhoods, villages, and the like. This regenerative energy system can also be employed to enable peak-shaving, i.e., during peak usage times, various units can be engaged to supply power to a given area (home, community, commercial entity/group, etc.), such that the grid power can be redirected to other areas needing additional power. For example, a telecommunication company can sell power from their cell tower back-up regen-system to the power company, thereby supplying the neighborhood located near the cell tower. Since the cell tower back-up regenerative energy system typically remains idle (e.g., the regen-system is idle for greater than 98% of the time the regen-system is at the cell tower site), the power company is assisted with local power, the consumers avoid blackouts/brownouts, and the telecommunication company generates revenue from an otherwise idle system.

Use of the regenerative energy system in a peak-shaving mode would entail operable communications between the regenerative energy system (e.g., the owners/operators of the regenerative energy system, and/or directly in operable communication with the regen-system) and the power grid, operable communication between the grid operators and the regenerative energy system, and other various centralized or distributed utility control and monitoring systems. The regenerative energy system may also be connected to facility control systems responsible for metering and billing functions for the purpose of revenue reconciliation. Peak-shaving may be performed as a method to assist the main power source in time of high demand or, alternately, may be advantageously used more often whenever the cost of peak versus non-peak energy will provide the regenerative energy system owner with a net-positive revenue source. In operation, either the operator or an automated facility control system would engage (turn on) the regenerative energy system such that electricity would be supplied from the regen-system to a desired area, for a preferred period of time or until regeneration of the regenerative energy system to replenish various reactants (e.g., hydrogen). The process of the operator engaging the regen-system may be conducted locally by manual actuation of the electrical distribution equipment, or from a remotely located control room. In addition, regeneration during electricity production is also possible.

As will be described in more detail herein, during operation of the regenerative energy system, the renewable power source provides power to a local grid and an electrochemical cell, which generates hydrogen gas. The hydrogen is stored in an appropriate container for later use. At such a point in time during the day or season when the power generation capability of the renewable power source declines (e.g. night time), the grid will need to offset the loss in capacity. The hydrogen previously stored is supplied to a hydrogen electrical generator that converts the hydrogen into electricity, which is then fed back into local grid. Power generation will continue until the hydrogen source is exhausted or the power is no longer required. Reasons for ending power generation may include, for example, the restoration of the grid power, restoration of renewable energy sources (such as solar, wind, wave power, or the like), or the determination that peak-shaving is no longer cost effective or no longer required.

Once the amount of hydrogen in the hydrogen storage system decreases below a pre-determined level, the electrolysis module is preferably engaged to replenish the hydrogen supply. Preferably, hydrogen will be replenished whenever the hydrogen storage level is below full, and there is power available from the renewable power source for the electrolysis operation.

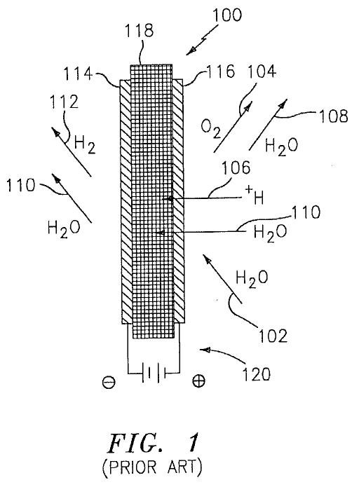

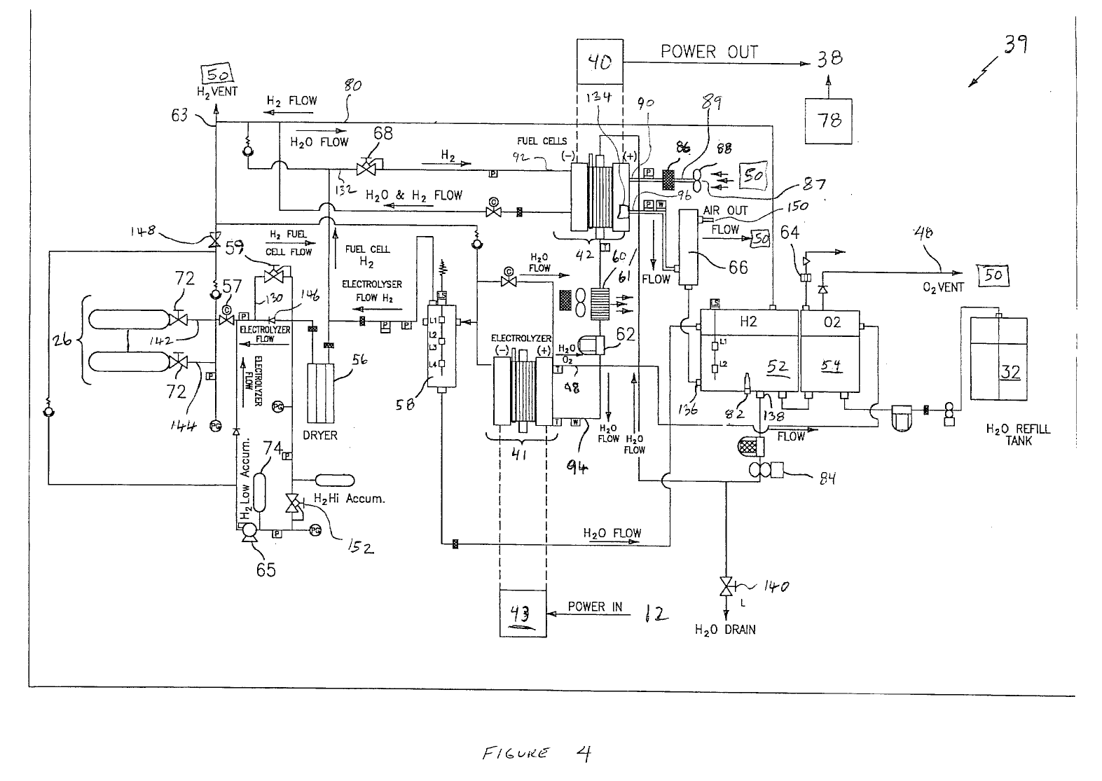

To create the hydrogen gas, an electrochemical cell device 100 is used. Electrochemical cells 100 are energy conversion devices, usually classified as either electrolysis cells or fuel cells. A proton exchange membrane electrolysis cell can function as a hydrogen gas generator by electrolytically decomposing water to produce hydrogen and oxygen gas, and can function as a fuel cell by electrochemically reacting hydrogen with oxygen to generate electricity. Referring to FIGS. 1 and 4, which is a partial section of a typical anode feed electrolysis cell 100, 41, process water 102 is fed into the electrolysis cell 100 on the side of an oxygen electrode (anode) 116 to form oxygen gas 104, electrons, and hydrogen ions (protons) 106. The reaction is facilitated by a positive terminal of a power source 120 electrically connected to anode 116 and a negative terminal of power source 120 electrically connected to a hydrogen electrode (cathode) 114. The oxygen gas 104, and a portion of the process water 108 exit the electrolysis cell 100, while protons 106 and water 110 migrate across a proton exchange membrane 118 to cathode 114 where hydrogen gas 112 is formed. The hydrogen gas 112 and the migrated water 110 exit electrolysis cell 100, 41 from the cathode side of the electrolysis cell 100.

Another typical water electrolysis cell 100 using the same configuration as is shown in FIGS. 1 and 4 is a cathode feed electrolysis cell 100, 42, wherein process water is fed on the side of the hydrogen electrode 114. A portion of the water migrates from the cathode 114 across the membrane 118 to the anode 116, wherein hydrogen ions and oxygen gas are formed due to a reaction facilitated by connection of a power source 120 across the anode 116 and cathode 114. A portion of the process water exits the cathode feed cell 100, 42 at the cathode side without passing through the membrane 118, while some excess water, as well as oxygen gas, exits the cathode feed cell 100, 42 at the anode side.

Referring to FIG. 4, the oxygen gas exiting the electrolysis cell 42 can be handled in various fashions, including venting directly to the atmosphere 50, passing through a phase separator 66 and storing part or all of the oxygen for use with the hydrogen electrical generator 34 (discussed below in reference to FIG. 2), as well as combinations having at least one of the foregoing options. Preferably, at least the water is recovered from the oxygen stream prior to venting to the atmosphere. When system simplicity is desired, it is especially preferred to pass the oxygen from the electrolysis cell 42 through a phase separator 66 prior to venting to the environment 50. The water from the phase separator 66 can be directed to the water storage device 52, 54 that is in fluid communication with the electrolysis cell 42.

Referring to FIG. 2, a local electrical grid 10 is shown. A renewable power source 12 produces electrical power for the local electrical grid 10. The renewable power source 12 may include sources such as a wind turbine, solar/photovoltaic, wave power, and the like, as well as combinations comprising at least one of the foregoing power sources. Depending on the type of renewable power source 12 used (e.g. wind turbine), an optional generator 14 may be connected to the power source 12 to generate the electrical power. The electricity from the renewable power source 12 is transmitted via an electrical conduit 16 to an electrochemical cell system 18 that produces hydrogen gas, which is stored in an appropriate hydrogen storage device 26. Hydrogen storage device 26 may be a high pressure tank, a metal hydride tank, or a carbon nano-fiber tank. The electrochemical cell system 18 produces hydrogen gas until the storage device 26 is full.

Excess power from the renewable power source 12, which is not being used to generate hydrogen gas, is routed to a transmission line 28 to the main portion of the grid. This excess power may be combined with other power sources such as a diesel generator 30 to provide adequate reliable power for a power load 36.

During times that the renewable power source 12 is unable to provide power to the local electrical grid 10, hydrogen gas stored in storage device 26 is provided to one or more hydrogen fueled electricity generators 31, which use the hydrogen gas to produce electricity for the local electrical grid 10. The electricity generators 31 include, but are not limited to, devices such as a fuel cell system 34 or an internal combustion engine genset 35. The fuel cell system 34 combines the hydrogen gas with oxygen to produce electricity through an electrochemical reaction. The internal combustion engine genset 35 utilizes a hydrogen fueled internal combustion engine to rotate a generator to produce the electricity. Any number of hydrogen fueled electricity generators 31 may be connected into the local electrical grid 10 depending on the amount of the hydrogen gas stored and the capacity needs of the local electrical grid 10.

The electrochemical cell system 18 comprises a number of components including a power conditioner 20, an optional battery 21, an electrochemical cell stack 22, and support systems 24. Input power from the renewable power source12 is converted by the power conditioner 20 to provide suitable power to the electrochemical cell stack 22.

The power conditioner 20 provides an interface between the power sources (e.g., renewable power source 12 and generator 14), and the electrochemical cell system 18. The power conditioner 20 preferably has three modes of operation. The first mode uses alternating current (AC) power from the grid 10 only. In this mode of operation, the power conditioner 20 would draw power from the local electrical grid 10 to operate both the cell support systems 24 and the electrolysis cell stack 22. The second mode of operation would operate the electrochemical cell system 18 using power from the renewable power source 12 only. The third mode of operation would be to utilize power from both the local electrical grid 10 and the renewable power source 12. In this third mode of operation, the power from the renewable power source 12 would be converted by the power conditioner 20 to operate the electrochemical cell stack 22. The remaining power requirements for the cell support systems 24 would draw from the local electrical grid 10.

It is preferred that the power conditioner 20 operate with a wide variety of sources having an input voltage range of about 48 to about 120 VDC (voltage direct current), with a preferred nominal voltage of about 75 VDC. In one embodiment, the preferred in-rush current of the power conditioner 20 is up to about 150 amps peak for about 5.6 milliseconds (ms). With these input parameters, the power conditioner 20 would have a preferred output power of about 6,000 watts (W) at a voltage (V) and current of 50V at 120 amps. Preferably, the output range of the power conditioner 20 would be adjustable to about +10% and about −20% of the nominal output voltage. Preferably, the power conditioner 20 also incorporates over-voltage, over-current, and/or over-temperature protection for the regen-system. Additionally, it is preferred that the power conditioner 20 include the capability of a 24 VDC power source to provide power to the cell support systems 24 and a battery charging capability of about 500W and about 20 amps at 24 VDC to the battery 21. It is especially preferred that the power conditioner 20 interface with grid power sources, e.g., 30, 34, 35 as well as renewable sources, e.g., 12.

Electrical power from renewable power sources 12 may not be constant due to factors such as, in the case of a wind turbine, a momentary slowing of the wind or in the case of a photovoltaic renewable source, cloud cover. Since the cell support systems 24 include components such as pumps, fans, and control devices, it is desired to keep these devices continuously operating to minimize the duty cycle and increase their life and reliability. To keep the momentary dips in the power from affecting the operation of the cell support systems 24, the power conditioner 20 preferably operates in its third mode of operation drawing power to run the cell support systems 24 from the local electrical grid 10. Optionally, the electrochemical cell system 18 could operate in the second mode (renewable power only) and utilize the optional battery 21 to provide a bridging power source for the support systems 24. Either the battery 21 or the local electrical grid connection 10 (power sources 30, 34, and/or 35) may be used singularly, or in combination, to provide a redundant power supply.

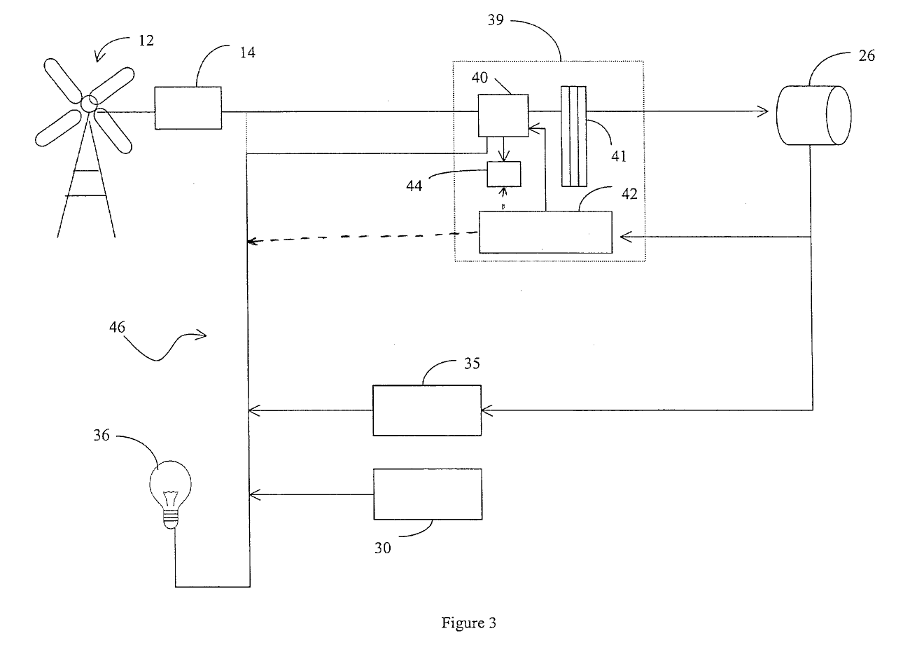

An alternate embodiment is shown in FIG. 3 of an electrochemical cell system designated by reference numeral 39. In this embodiment, a regenerative fuel cell module 42 is incorporated into the electrochemical cell system 39 to provide power to both the support systems 44 and a local electrical grid 46. Power from the renewable power source 12 provides electrical power to the electrochemical module 41 via a power conditioner 40. The electrochemical module 41 produces hydrogen gas and stores it in the hydrogen storage device 26. To provide power for the electrochemical module 41, a small amount of hydrogen can be fed back to the electrochemical cell system 39 for use by the fuel cell module 42. The fuel cell module 42, in turn, provides power to operate the support systems 44. Alternatively, the fuel cell module 42 may be sized appropriately to provide additional power for the local electrical grid 46. It should be noted that the fuel cell module 42 may be connected to the support systems 44 and the local electrical grid 46 through the power conditioner 40 that corrects power deviations or, the fuel cell module 42 may be connected directly to the support systems 44 and the local electrical grid 46. The hydrogen storage device 26 may also be connected and supply hydrogen gas to multiple hydrogen fueled electricity generators 35.

FIG. 4 is a detailed block diagram representing the regenerative electrochemical cell 39 shown in FIG. 3. The regen-system 39 comprises an electrolysis module (or stack) 41 in fluid communication with an oxygen-releasing vent 48 that fluidly communicates with the surrounding atmosphere 50. Optionally, disposed between the electrolysis module 41 and the oxygen vent 48 is a water storage device 52 54, which is in fluid communication with the cathode chamber of the electrolysis module 41. Also, hydrogen storage device 26 is in fluid communication with the electrolysis module 41, with an optional phase separation device 58 disposed therebetween. The hydrogen storage device 26 is further in fluid communication with the fuel cell module 42, preferably via optional dryer 56. Meanwhile, the fuel cell module 42 is in fluid communication with the surrounding atmosphere 50 via oxygen/water phase separation device 66, and via water storage device 52, 54 and oxygen vent 48. In addition, the fuel cell module 42 is in electrical communication with a power load 38 via a power conditioner 40, and optionally in electrical communication with a bridge power device 78, which is also in electrical communication with the power load 38. Meanwhile the electrolysis module 41 is in electrical communication with the renewable power source 12, via power conditioner 43. Optionally, the bridge power device 78 is integrated with the renewable power source 12 as a single device.

The electrolysis module 41 can have any desired number of electrolysis cells 100, depending upon the desired rate of hydrogen production. Each electrolysis cell 100 includes an electrolyte, depicted as 118, disposed between, and in ionic communication with, electrodes 114, 116. One of the electrodes 116 is in fluid communication with a water source (e.g., 54, 52, 32, a continuous water supply, or the like), while the other electrode 114 is in fluid communication with the fuel cell module 42, preferably via a phase separation device 58 and the hydrogen storage device 26.

The water storage device 52, 54 contains a water intake port 136 and a water output port 138. The water intake port 136 is in fluid communication with fuel cell module 42 and the output port 138 is in fluid communication with a water pump 84 that is in fluid communication with the electrolysis module 41. Depending upon the design of the water storage device 52, 54, a single tank can be employed to recover water from the hydrogen and the oxygen outlets from the fuel cell module 42, or separate water storage devices (e.g., 54, 52) can be employed. Furthermore, depending upon the availability of make-up water for the system 39, a backup water storage device 32 may also be employed. Alternatively, or in addition, the water storage device 52, 54 can optionally be in fluid communication with a continuous water source (e.g., a lake, a river, a municipal water supply, and the like, as well as combinations comprising at least one of the foregoing water sources).

Additionally, the water system (i.e., the water storage device(s), and fluid communication conduits) may comprise a heating system 82 to increase the temperature of the water, thereby reducing fuel cell startup time. This heating system may include resistance heaters within and/or around the piping system and/or within the water storage devices (e.g., heater 82 as shown in water storage device 52, 54). The heating system 82, alternatively, may constitute both a heating system component and a plumbing system component, such as a tube heater that serves the dual function of being a piping connection. Alternately, the heater 82 may be incorporated in an element of the fuel cell module 42 or the electrolysis module 41 in the form of an integrated component with the heating element forming part of an end plate or fluid communication section of the module. Alternatively, the heating method may utilize a radiant heating method such as an infrared source within the system or externally located. These heaters 82 may be in the form of a mat, a tube, a coil, a rod style heater, and others, as well as combinations comprising at least one of these heaters. Alternately, the heater 82 may be part of a thermal management or hydration sub-system whose fluid may be other than water based.

The heating system 82 may further comprise freeze protection, as part of the above-described system or via additional components. Freeze protection can be attained by employing various insulative measures to minimize heat loss, isolation valves 140 that allow draining of water from non-freeze tolerant components of the regen-system 39, such as water pump(s) 84, and the like. Alternately, continuous water flow may be utilized with the heating system, and/or the heating system may utilize parasitic loads (e.g., heat generated by the water pump, control system electronics, and the like) to create the heat energy and prevent water freezing during low ambient temperature operation (e.g., −30° F. (degrees farenheit). The use of parasitic heat can be employed in combination with various controls in support system 44, such as a temperature sensor, and the like, such that the pump 84 may be operated continuously, or the pump 84 can be operated intermittently based upon factors such as the actual water temperature.

Water pump 84, in fluid communication with both the water storage device 52, 54 and the electrolysis module 41, can optionally allow two-way water flow. Therefore, during electrolysis module 41 recharge operations, water pump 84 can allow excess water that accumulates in the regen-system 39 to flow into water storage device 52, 54, preventing flooding of the regen-system 39. This pump 84, which can be in fluid communication with the electrolysis module 41 via the fuel cell module 42, is preferably capable of discharging the desired water to the electrolysis module 41 at a pressure to enable efficient regen-system operation. For example, the water pump 84 is preferably capable of discharging water to the electrolysis module 41 at a pressure up to and exceeding about 2.1 megaPascals (MPa) (300 pounds per square inch (psi)) during fuel cell module 42 operation.

As with the water storage device 52, 54 and the water pump 84, the hydrogen storage device 26 is in fluid communication with the electrolysis module 41. The hydrogen storage device 26 comprises a hydrogen gas intake port 142 and a hydrogen gas output port 144. The hydrogen gas intake port 142 is in fluid communication with electrolysis module 41, while the hydrogen gas output port 144 is in fluid communication with the fuel cell module 42.

Within the hydrogen storage device 26, the hydrogen may be stored at various pressures, depending upon the hydrogen storage device 26 design and the storage needs of the regen-system 39. Preferably, the hydrogen storage device 26 is a pressurized device suitable to store hydrogen gas at pressures of up to, or exceeding, about 1,000 pounds per square inch (psi), with the capability of storing hydrogen gas at pressures of up to, or exceeding, about 2,000 psi preferred and about 10,000 psi more preferred.

The desired hydrogen storage pressure may be achieved through the use of the electrolysis module 41 alone or in concert with a pressure boosting system (e.g., a compressor 65) within the regen-system 39. Alternatively, or in addition, the hydrogen storage device 26 may include mechanical or other pressure increasing methods, such as metal hydride pumping or proton exchange membrane (PEM) based pumping systems for example. Any pumping system may use a single stage or multiple stages to achieve the desired final compression level. The compression techniques may be used in various combinations or quantities to achieve the required compression within the system.

In an alternative to employing pressurized hydrogen storage device(s) 26, other techniques of storing hydrogen can be employed; e.g., hydrogen can be stored in the form of a gas, solid, or liquid. For example, if a non-pressurized device is employed the hydrogen can be stored as a solid, e.g., as a metal hydride, in a carbon based storage (e.g., particulates, nanofibers, nanotubes, or the like), and others, as well as combinations comprising at least one of the foregoing hydrogen storage forms.

Hydrogen storage device 26 can be formed of any material capable of withstanding the desired pressures. Some possible materials include ferrous materials (such as steel, e.g., stainless steel, and the like) titanium, carbon (e.g., woven carbon fiber materials, and the like), plastics, any other comparable high-strength materials, as well as composites, alloys, and mixtures comprising at least one of the foregoing materials. Furthermore, the hydrogen storage device 26 may be lined with sealant(s), surface finish(es), coatings, or the like, to prevent corrosion or other tank material-related contamination from communicating with the hydrogen or any condensate in the device, and to prevent the contamination of regen-system components.

Hydrogen gas drying techniques may also be employed as part of the hydrogen storage system. These drying systems 56 may include, for example, desiccant based drying schemes (e.g., a swing bed adsorber, and other desiccant based absorbers), phase separators, membrane drying systems (e.g., palladium diffusers, and the like), coalescing filters, condensing systems (e.g., utilizing thermal electric cooler, vortex tube coolers, vapor or air cycle refrigeration system, and the like), and the like, as well as combinations comprising at least one of the foregoing drying systems.

Optionally, the hydrogen storage system 26 can comprise an inverted hydrogen storage device (i.e., a hydrogen storage device comprising a bi-directional opening (inlet and outlet), and/or which allows hydrogen removal from an upper vessel connection, while water is removed via a gravity drain port (not shown). In the inverted hydrogen storage device, the device is allowed to collect condensed moisture and return this condensed liquid to the water storage device 52, 54 or other water sub-system components. Alternatively, the inverted hydrogen storage device 26 can be used as a secondary water separator when used with a primary water separator, e.g., hydrogen/water phase separation device 58 (which may comprise multiple stages of separators to improve water extraction and recovery). Employing the inverted hydrogen storage device eliminates the need for a dryer 56 and associated hardware. Further eliminated is the need for a compressor 65 if the electrolysis module 41 is operated to produce hydrogen at a desired storage pressure.

In fluid communication with the hydrogen storage device 26 are optional dryer(s) 56, and the fuel cell module 42. The dryer 56 can comprise any device capable of removing water vapor from the hydrogen stream, as discussed above. Some water is removed from the saturated hydrogen stream at the phase separation device 58. Saturated hydrogen gas from the phase separation device 58 then flows into dryer 56 (having a lower water saturation than the feed stream to phase separation device 56). In an embodiment, the dryer 56 includes a bed of a moisture absorbent (and/or adsorbent) material, i.e., a desiccant. As the saturated hydrogen gas flows into the dryer 56, water with trace amounts of hydrogen entrained therein is removed and subsequently returned to the water source, or water storage device 52, 54, through a low-pressure hydrogen separator 74. Low pressure hydrogen separator 74 allows hydrogen gas to escape from the water stream due to the reduced pressure, and also recycles water to electrolysis module 41 at a lower pressure than the water exiting the phase separation device 58. Alternatively, a diffuser 146 may be provided in addition to the dryer 56, with a one-way check valve 72 preferably disposed between the hydrogen storage device 26 and the dryer 56 to prevent high-pressure backflow of the hydrogen gas.

Although the dryer 56 is preferably sized to hold all moisture generated during electrolysis based on the size of the hydrogen storage system, the dryer 56 has limited capacity for water removal. The dryer 56 is therefore preferably periodically purged to remove accumulated moisture. Purging the dryer 56 is accomplished by flowing stored hydrogen gas from the hydrogen storage device 26 through the dryer bed of dryer 56. As the hydrogen gas from hydrogen storage device 26 flows through the dryer 56, the dryer bed is purged of its moisture. A first pressure regulator 59 is fluidly connected between the storage hydrogen storage device 26 and the dryer 56. The pressure regulator 59 reduces the gas pressure from the hydrogen storage device 26 to provide an efficient and low cost solution for purging the dryer 56. The use of the first pressure regulator 59 minimizes the amounts of hydrogen gas vented (lost) to the atmosphere and provides a more efficient process for bed desorption. Moreover, the use of the first pressure regulator 59 prevents high-pressure gas exposure to the phase separator 58 from hydrogen storage device 26. As will be discussed in greater detail, the pressure regulator 59 is preferably set at or about the operating pressure for the fuel cell module 42. More preferably, the pressure is set a few pounds per square inch greater than the operating pressure for the fuel cell module 42. Preferably, the pressure regulator 59 is set at a pressure of less than or equal to about 14 psi greater than the fuel cell operating pressure, with a pressure of less than or equal to about 7 psi more preferred. Also preferred is a pressure of greater than or equal to about 2 psi greater than the fuel cell operating pressure, with a pressure of greater than or equal to about 3 psi more preferred.

The purging process comprises passing the reduced pressure hydrogen through the dryer 56 and desorbing the previously absorbed (and adsorbed) water from the dryer 56. The now hydrated hydrogen can either be vented to the atmosphere 50, and/or all or a portion of the hydrated hydrogen can preferably be directed to the fuel cell module 42 for consumption and possibly subsequent water recovery. Preferably, the dryer 56 acts as a hydrogen humidification device to inhibit fuel cell electrolyte dry-out. Alternatively, the vented hydrated hydrogen may be consumed in a combustion or a catalytic burner (not shown), or the like.

The fuel cell module 42 is used to generate energy during a power generation mode. During the power generation mode, a control valve 148 is actuated (and preferably left open while in idle mode), and hydrogen gas flows from the hydrogen storage device 26 to the fuel cell module 42. Hydrogen gas electrochemically reacts with oxygen (O₂) in the fuel cell module 42 to release energy and form by-product water. This water is preferably retained in the system 39. The oxygen gas can be either stored as pressurized gas or supplied from ambient air. A second pressure regulator 68 is fluidly connected to an inlet 92 of the fuel cell module 42. The second pressure regulator 68 is set at the optimal operating pressure of the fuel cell module 42. Preferably, the second pressure regulator 68 is set at about 40 psi. The second pressure regulator 68 protects the fuel cell module 42 from the high pressures obtained during hydrogen gas generation (pressures up to and exceeding about 4,000 psi) and acts as a secondary pressure reducer. The second pressure regulator 68 also serves as a redundant mechanism in the event of a check valve 72 fault or leak.

As previously discussed, the first pressure regulator 59 is preferably set at a pressure rating above the rating for second pressure regulator 68 (e.g., a few psi greater than the pressure rating for regulator 68). Under these conditions, the first pressure regulator 59 can function as a backup to second pressure regulator 68 in the event of a “wide open” fault of regulator 68. Moreover, since the first pressure regulator 59 is set at a value greater than the second pressure regulator 68, pressure is continuously maintained to the fuel cell module 42, even during electrolysis. Since it is preferred not to employ shutoff or multi-way valves that need to be actuated between the hydrogen storage device 26 and fuel cell module 42, the fuel cell module 42 is always ready to operate. A shutoff valve 57, normally disposed between the hydrogen storage device 26 and the dryer 56 is open when the regen-system 39 is operational; it is typically only closed for system faults or system shutoff. As a result, the switching delays caused by valve actuation are eliminated as the regen-system 39 cycles between the charging/storage mode (e.g., hydrogen generation) and the power generation mode. During the power generation mode, the use of first pressure regulator 59 causes a low pressure purging gas to flow into dryer 56 and desorb the bed of accumulated moisture. This permits the regen-system 39 to employ a lower cost phase separation device 58 and to optionally eliminate check valves at the separator outlet. Use of the lower pressure operated phase separation device 58 is particularly preferred when the system 39 employs a hydrogen pressure boosting system (e.g., a compressor 65 or the like), due to its low cost.

From the dryer 56, hydrogen gas flows to the fuel cell module 42. The fuel cell module 42 includes any desired number of fuel cells 100, based upon the desired power supply capabilities of the regen-system 39. Each fuel cell 100 within the fuel cell module 42 has an electrolyte, depicted as 118, disposed between, and in ionic communication with, two electrodes 114, 116. One electrode 114 is in fluid communication with a hydrogen supply (e.g., hydrogen storage device 26 and/or electrolysis module 41), while the other electrode 116 is in fluid communication with an oxygen supply (e.g., the surrounding atmosphere 50, the gaseous phase of the water storage device 52, the gaseous phase of the oxygen/water phase separation device 66, and/or an oxygen storage device (not shown)).

If the fuel cell module 42 is in fluid communication with the surrounding atmosphere 50, reduction of any pressure differentials between the fuel cell module 42 and the surrounding atmosphere 50, as well as uptake of air from the surrounding atmosphere 50, and filtering of the air, can be accomplished by various methods, including, for example, using an air compressor(s), depicted generally at 88, fan(s), also depicted generally at 88, filter(s) 86, and the like, as well as combinations comprising at least one of the foregoing methods. For example, the air compressor 88 contains an air intake port 87 and an air output port 89. The output port 89 is in fluid communication with fuel cell module 42 and the intake port 87 is in fluid communication with the surrounding atmosphere 50. Air compressor 88 draws air from the surrounding atmosphere 50, compresses it, and then the compressed air to fuel cell module 42. The generation of compressed air by air compressor 88 facilitates air uptake by fuel cell module 42.

In electrical communication with the fuel cell module 42 is a power load 38. The power load 38 can be a direct current (DC) load or an alternating current (AC) load and can include those discussed above, e.g., residential, commercial, and the like (including batteries for powering those power loads) with the electricity from the fuel cell module 42 appropriately conditioned by power conditioner 40. Furthermore, the regen-system 39 can be connected directly to the power load 38 with sensors, not shown, capable of drawing power upon the various conditions, e.g., cease of grid power flow, increased power demand over a predetermined amount, operation for system testing, commands from centralized or distributed control systems (e.g., connected via various methods including wireless, wired (e.g., modem, and the like)), infrared and radio frequency commands, and the like, as well as combinations comprising at least one of the foregoing command systems. These command systems may further include operations devices in operable communication with the regen-system, such as communication devices and control devices. Possible operations devices include processing units (e.g., computers, and the like) and similar equipment.

In contrast to the fuel cell module 42, the electrolysis module 41 is connected to a renewable power source 12. The renewable power source12 can be any device capable of providing sufficient power to the electrolysis module 41 to enable the desired hydrogen production rate. Some possible renewable power sources 12 include grid power, battery, solar power, hydroelectric power, tidal power, wind power, and the like, as well as combinations comprising at least one of the foregoing power sources (e.g., via solar panel(s), wind mill(s), dams with turbines, and the like).

The renewable power source 12 can introduce either AC or DC power to the regen-system 39, preferably via a power conditioner 43. The power conditioner 43 may provide control of the energy source, e.g., current control, voltage control, switch control, as well as combinations of these controls, and the like. The power conditioner 43, and/or a control system (not shown), can monitor voltage, current, or both, in order to control the power from the power conditioner 43.

In addition to the power that passes out of the regen-system 39 via the power conditioner 40, heat energy may be recovered from the regen-system 39 with a heat exchanger 60 and/or radiator 61. The heat exchanger 60 can be disposed in fluid communication with both the fuel cell module 42 and the electrolysis module 41 such that the heat produced in the electrolysis module 41 can be employed to heat the fuel cell module 42. Alternatively, or in addition, the heat exchanger 60 and/or radiator 61 can be in thermal communication with the surrounding environment 50, or can be directed to a thermal load; e.g., a building (such as an office building(s), house(s), shopping center, and the like).

In addition to the above equipment, the regen system 39 may further comprise various other equipment, such as valves (e.g., relief valves, check valves, manual valves, actuated valves, needle valves, and the like, as well as combinations comprising at least one of the foregoing valves), filters (e.g., deionization bed cartridge(s), filter cartridge(s), and the like, as well as combinations comprising at least one of the foregoing filters), sensors (e.g., pressure, temperature, flow, humidity, conductivity, gas mixture, water level, and the like, as well as combinations comprising at least one of the foregoing sensors), controls (e.g., temperature (such as, heaters, heat exchangers, coolers, dryers, and the like), pressure (such as, compressors, and the like), flow (such as, pumps, fans, blowers, and the like), power, and the like, as well as combinations comprising at least one of the foregoing controls), conduits (e.g., fluid conduits, electrical conduits, and the like), and the like, as well as combinations comprising at least one of the foregoing equipment. It should be noted that, depending upon regen-system location (remote, metropolitan, industrial, and the like), its specific function (e.g., front line electrical production, backup production), and the criticality of the source that the regen-system is backing-up, redundant components or merely additional components can be employed, in parallel or series operation. For example, water storage devices, dryers, heat exchanger, radiators, deionization beds, filters, phase separation devices, and the like.

The process by which the regenerative electrochemical cell system is operated will now be described in reference to FIG. 4. Stored hydrogen gas from hydrogen storage device 26 is fed into fuel cell module 42, preferably via first pressure regulator 59 and dryer 56. Air from the surrounding atmosphere 50 is directed to the fuel cell module 42 via filter 86 and fan 88. Optionally, the air can be compressed at compressor 88 prior to entering the fuel cell module to attain the desired air pressure. Within the fuel cell module 42, the hydrogen and the air electrochemically react to generate electricity, and by-product water. The electricity is directed from the regen-system 39 to the power load 38 through power conditioner 40. Meanwhile, exhaust, that is, excess air and product water are directed to the water storage device 52, 54 via the phase separation device 66. Optionally, the oxygen separated from the water/air stream, can be retained for subsequent use in the fuel cell module 42 (e.g., to reduce start-up time), or routed for use with an internal combustion engine, or can be vented via oxygen vent 48 to the surrounding atmosphere 50. Similarly, the hydrogen and water from the fuel cell exhaust is directed from the fuel cell module 42 to water storage device 52, 54, with excess hydrogen, as well as nitrogen that may have migrated across the electrolyte, optionally being vented via vent 63.

To enhance the water recovery, that is, to minimize water loss, one or more dehumidifiers (dryers) 56, 64 can be added to the regen-system 39. The dehumidifier 56, 64 serves to re-condense and hence recapture water vapor prior to venting. In one embodiment, in addition to the dryer 56, dryer 64 can be employed. Dryer 56 is disposed in fluid communication with the hydrogen storage device 26, the electrolysis module 41, and the water storage device 52, 54, whereas dryer 64 is disposed in fluid communication with water storage device 52 54. The optional dryer 64 enables the removal of water vapor from the oxygen purge stream that may also include other air components (e.g., nitrogen, carbon dioxide, and the like).

Dehumidification of vented water may also be utilized on the air/water stream from the exhaust of fuel cell module 42 to preserve total system water volume. This dehumidification would take place on the outlet of the fuel cell at the exhaust air port 150. In one embodiment, a separate phase separator (e.g., an air/water phase separator 66) may collect recovered water. The water can then be pumped or gravity fed to the electrolysis module 41. Alternatively, all or a portion of the recovered water, may be directed to the water storage device 52, 54.

The water reclamation system may partially or completely employ heat exchange with the surrounding atmosphere 50 (e.g., ambient air), may employ another fluid available to the regen-system 39, may create a cold condensing surface using active refrigeration (e.g., thermal electric cooler, air cycle refrigeration, vapor cycle refrigeration, and like), and the like, as well as combinations comprising at least one of the foregoing thermal transfer techniques. For example, the heat exchange may use pressurized air exiting the fuel cell by passing the air through a vortex tube cooler 134. As the air passes through the vortex tube cooler 134, the air cools, producing a cold air stream and a hot air stream, wherein the hot air stream is vented to the surrounding atmosphere while the cold air steam is used to condense water in the air stream. The condensed water and air exiting the cooler is then separated in a water/air phase separator 66. The vortex tube 134 generates both a hot and cold air source where the cold air source is used for condensation control and recovery, and the hot air source is typically vented. One example of a suitable vortex tube 134 is commercially available from the Exair Corporation under the trade name Vortex Tube Model 3202 fitted with cold muffler model 3905 and hot muffler model 3903; other options or combinations that yield the required cold air source may also be used. Furthermore, the vortex tube 134 can be used to recover water or may be used merely for thermal exchange, e.g., to heat or cool the fuel cell, as desired. Since the vortex tube 134 does not employ moving parts, it is a preferred technique for applications that do not have a high fluid flow rate (e.g., greater than or equal to about 150 cubic feet per minute (CFM)).

The reclaimed water, e.g., from the vortex tube 134, phase separation devices 58, 66, and the like, is preferably directed to one of the water storage devices 54, 52. These water storage devices 54, 52 store the water and preferably provide additional phase separation to separate any hydrogen or oxygen gases from the liquid water phase. Water storage device 52, preferably receives condensed water from the hydrogen/water phase separation device 58, from the oxygen/water phase separation device 66, and, from water in the hydrogen conduits (e.g., conduit 80), while water storage device 54 preferably receives the water/oxygen stream exiting from the water electrode of the electrolysis module 41.

The fuel cell module 42 operates until the hydrogen gas source is depleted or other control system inputs indicated that power generation is no longer desired. When renewable power 12 is available, or when power generation is desired (e.g., in peak-shave type applications), the electrolysis module 41 can be operated to provide hydrogen gas directly to the fuel cell module 42 or to replenish the hydrogen storage device 26. Operation of the electrolysis module 41 includes directing water to the electrolysis module 41. Water can be introduced to the electrolysis module 41 directly from one or both of the water storage devices 54, 52, or can be introduced to the electrolysis module 41 via the fuel cell module 42. Preferably, water from the water storage device 52, 54 passes through the fuel cell module 42 as a coolant, and into a heat exchanger/radiator 60/61. From the heat exchanger/radiator 60/61, the water passes through an optional deionization bed 62 and to the water electrode of the electrolysis module 41. In the electrolysis module 41, the power supplied to the electrolysis cell via renewable power source 12 and power conditioner 43 enables the electrolysis of water to hydrogen ions and oxygen gas. The oxygen gas, along with excess water are directed to the oxygen/water phase separation device 66, while the hydrogen ions, and some water, migrate across the electrolyte 118 to the hydrogen electrode 114 where the hydrogen ions form hydrogen gas. From the electrolysis module 41, the hydrogen gas and water can be directed to an optional hydrogen/water phase separation device 58, and then the hydrogen can either be directed to the fuel cell module 42 or to an optional dryer (e.g., dehumidifier, desiccant or the like) 56 and into the hydrogen storage device 26. Depending upon the desired storage pressure of the hydrogen and the hydrogen side pressure of the electrolysis module 41, a compressor 65 may optionally be employed to increase the hydrogen pressure prior to introduction to the hydrogen storage device 26 at the desired pressure as discussed above. Additionally, pressure reducing devices and associated accumulation devices, depicted generally at 152, may be used to stabilize and regulate inlet pressure to the compressor 65.

The regenerative electrochemical cell systems 39 described herein can be employed without the requirement of bulk oxygen storage, thereby simplifying the system, and reducing the system overall size. Removing capacity limitations allows the systems to be used in practical applications such as large-scale energy production. Further, the system 39 described is regenerative in the sense that the hydrogen gas needed for operation is supplied by the system eliminating the need for costly and time-consuming additions of hydrogen-generating reactants. This system effectively allows for efficient, practical, and long-term use.

Due to the flexibility and environmental compatibility of the regen-system 39, it can be employed anywhere from in metropolitan areas to remote, e.g., third world locations. This system 39 can employ any power source (e.g., AC, DC, 24V, 48V, 120V, 240V, and the like), and can backup any power load (e.g., AC, DC, 24V, 48V, 120V, 240V, and the like). Additionally, the fuel cell module 42 can be fueled directly by the electrolysis module 41, or, while the fuel cell module 42 is drawing fuel (hydrogen) from the hydrogen storage device 26, the electrolysis module 41 can supply hydrogen to the hydrogen storage device 26. Additionally, in applications where water addition is practical, or where larger water storage is economically feasible, the backup power system can also supply hydrogen gas as a direct fuel source for various applications such as appliance fueling (e.g., laboratory equipment such as chromatographs, and the like), vehicle fueling (e.g., automotive, other transportation vehicles, and the like), or other applications where hydrogen is a reactant gas, feedstock, or fuel application, while the regen-system retains the primary function of an electrical power systems.

In addition to reduced size and storage requirements, the regen-system 39 maximizes the utility of various components. For example, the dryer 56 and/or the hydrogen/water phase separation devices 58, 66, are employed to remove water from the hydrogen stream prior to storage to simplify storage, enhance capacity, and inhibit corrosion of the dryer/storage device 56, 26, and to humidify the hydrogen stream prior to its introduction to the fuel cell module 42 to inhibit electrolyte dry-out.

Unlike renewable power systems that dispose of excess energy in the form of heat (e.g., heating water), the present power system 39 stores excess power in the form of hydrogen gas. Stored as hydrogen gas, the excess energy can be recovered and used in an amount when desired. Furthermore, by connecting the support systems (e.g., fan(s), pump(s), sensor(s), and the like (discussed above), to a local electrical grid 10, 46 or other reliable power source (e.g., battery 21 or the like), the inconsistency of the renewable power source 12 does not affect the operation of the system 39. Still further, the regen-systems 39 described herein create the hydrogen gas at pressure without the use of secondary compressors (optionally included at 65), thereby permitting coupling of the regen-systems 39 with the renewable power sources 12, which may have lower power outputs than are available in grid connected systems 30.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An energy storage and recovery system, comprising:
a renewable power source;
a hydrogen generation device in electrical communication with the renewable power source;
a hydrogen storage device in fluid communication with the hydrogen generation device;
a hydrogen fueled electricity generator in fluid communication with the hydrogen storage device; and
a pressure regulator interposed between and in fluid communication with the hydrogen fueled electricity generator and the hydrogen storage device, the pressure regulator being set at about an operating pressure of the hydrogen fueled electricity generator.

2. The energy storage and recovery system according to claim 1, wherein the renewable power source comprises a diesel generator, a wind turbine, a hydro turbine, a natural gas generator, a photovoltaic array or combinations comprising at least one of the foregoing renewable power sources.

3. The energy storage and recovery system according to claim 1, wherein the hydrogen generation device comprises an electrolysis module responsive to electricity and water for generating hydrogen.

4. The energy storage and recovery system according to claim 1, wherein the hydrogen storage device comprises a pressurized tank, an inverted hydrogen storage tank, a metal hydride tank, a carbon nano-fiber tank, or combinations comprising at least one of the foregoing hydrogen storage devices.

5. The energy storage and recovery system according to claim 1, wherein the hydrogen fueled electricity generator comprises a fuel cell module or an internal combustion engine genset responsive to hydrogen for producing electricity.

6. The energy storage and recovery system according to claim 1, further comprising a power conditioner interposed between and in electrical communication with the renewable power source and the hydrogen generation device.

7. The energy storage and recovery system according to claim 1, wherein the pressure regulator is set at about 40 psi.

8. The energy storage and recovery system of claim 1, further comprising a second pressure regulator interposed between and in fluid communication with the first pressure regulator and the hydrogen fueled electricity generator.

9. The energy storage and recovery system of claim 8, wherein the second pressure regulator is set at about 40 psi and the first pressure regulator is set at a pressure value equal to or greater than about 40 psi.

10. The energy storage and recovery system of claim 8, wherein the first pressure regulator is set at a pressure value exceeding the setting of the second pressure regulator by an amount equal to or greater than about 2 psi and equal to or less than about 14 psi.

11. The energy storage and recovery system of claim 10, wherein the first pressure regulator is set at a pressure value exceeding the setting of the second pressure regulator by an amount equal to or greater than about 3 psi and equal to or less than about 7 psi.

12. The energy storage and recovery system of claim 1, wherein the hydrogen storage device stores hydrogen gas at a pressure of equal to or greater than about 1,000 psi.

13. The energy storage and recovery system of claim 12, wherein the hydrogen storage device stores hydrogen gas at a pressure of equal to or greater than about 2,000 psi.

14. The energy storage and recovery system of claim 13, wherein the hydrogen storage device stores hydrogen gas at a pressure of equal to or greater than about 10,000 psi.

15. The energy storage and recovery system of claim 1, wherein the hydrogen storage device stores hydrogen in at least one of a gaseous, liquid and solid form.

16. The energy storage and recovery system of claim 1, further comprising:
a dryer interposed between and in fluid communication with the hydrogen generation device and the hydrogen storage device;
whereby the dryer dehumidifies the hydrogen prior to storage to inhibit corrosion of the storage device.

17. The energy storage and recovery system of claim 16, wherein the dryer is further interposed between and in fluid communication with the hydrogen storage device and the hydrogen fueled electricity generator;
whereby the dryer humidifies the hydrogen prior to introduction to the hydrogen fueled electricity generator to inhibit electrolyte dry-out.

18. A local power grid powered by the energy storage and recovery system of claim 1.

19. An energy storage and recovery system, comprising:
a renewable power source;
a regenerative electrochemical cell system having an electrolysis module and a fuel cell module, the regenerative electrochemical cell system in communication with the renewable power source;
a hydrogen storage device in fluid communication with the electrolysis module and the fuel cell module;
a first pressure regulator disposed between the hydrogen storage device and the electrolysis module;
a second pressure regulator disposed between the fuel cell module and the hydrogen storage device, wherein the first pressure regulator is set at a pressure greater than the pressure that the second pressure regulator is set at; and
a power conditioner interposed between and in electrical communication with the renewable power source and the regenerative electrochemical cell system.

20. The energy storage and recovery system according to claim 19, further comprising:
a dryer disposed between the hydrogen storage device and the electrolysis module;
whereby the dryer dehumidifies the hydrogen prior to storage to inhibit corrosion of the hydrogen storage device.

21. The energy storage and recovery system according to claim 20, wherein:
the dryer is further disposed between the hydrogen storage device and the fuel cell module;
whereby the dryer humidifies the hydrogen prior to introduction to the fuel cell module to inhibit electrolyte dry-out.

22. The energy storage and recovery system according to claim 19, wherein:
the fuel cell module includes a fuel cell outlet in fluid communication with a water storage device and a fuel cell inlet in fluid communication with an oxygen source and the hydrogen storage device; and
the electrolysis module includes an electrolysis cell inlet in fluid communication with the water storage device and an electrolysis cell outlet in fluid communication with the fuel cell inlet.

23. The energy storage and recovery system according to claim 19, wherein the pressure that the first pressure regulator is set at is a pressure of less than or equal to about 14 psi greater than the pressure that the second pressure regulator is set at.

24. The energy storage and recovery system according to claim 19, wherein the pressure that the first pressure regulator is set at is a pressure of less than or equal to about 7 psi greater than the pressure that the second pressure regulator is set at.

25. The energy storage and recovery system according to claim 19, wherein the pressure that the first pressure regulator is set at is a pressure of greater than or equal to about 2 psi greater than the pressure that the second pressure regulator is set at.

26. The energy storage and recovery system according to claim 19, wherein the hydrogen storage device stores hydrogen gas at a pressure of equal to or greater than about 1,000 psi.

27. The energy storage and recovery system according to claim 19, wherein the hydrogen storage device stores hydrogen in at least one of a gaseous, liquid and solid form.

28. A local power grid powered by the energy storage and recovery system of claim 19.

29. A method for operating an energy storage and recovery system, comprising:
generating and conditioning electrical power from a renewable power source;
powering an electrochemical cell system with the conditioned electrical power and water to electrolytically produce hydrogen gas;
drying the hydrogen gas in a dryer to remove water;
storing the hydrogen gas at a first pressure; and
supplying the hydrogen gas at a second pressure to a hydrogen fueled electricity generator to produce electrical power in response to the electrical power generated by the renewable power source being less than or equal to a selected level;
wherein the hydrogen gas flows through the dryer and absorbs water prior to flowing into the hydrogen fueled electricity generator; and
wherein the second pressure is less than the first pressure.

30. The method for operating the energy storage and recovery system of claim 29, wherein conditioning the electrical power from the renewable power source comprises:
operating a power conditioner in at least one of a first mode, a second mode, or a third mode of operation;
the first mode of operation using alternating current power from the local grid only to operate the electrochemical cell system and support systems for the energy storage and recovery system;
the second mode of operation using power from the renewable power source only to operate the electrochemical cell system; and
the third mode of operation using power from the local grid and the renewable power source to operate an electrolysis cell in the electrochemical cell system.

31. The method for operating the energy storage and recovery system of claim 29, wherein conditioning the electrical power from the renewable power source comprises:
operating a power conditioner with power sources having an input voltage range of about 48 VDC to about 120 VDC.

32. The method for operating the energy storage and recovery system of claim 29, further comprising charging a battery with the conditioned electrical power.

33. The method for operating the energy storage and recovery system of claim 29, wherein supplying the hydrogen gas at a second pressure to a hydrogen fueled electricity generator to produce electrical power comprises:
introducing the hydrogen gas to a fuel cell hydrogen electrode, introducing oxygen gas to a fuel cell oxygen electrode, converting at least a portion of the hydrogen gas to hydrogen ions, and reacting the hydrogen ions with the oxygen gas to generate electricity and water.

34. The method for operating the energy storage and recovery system of claim 29, wherein the second pressure is at about an operating pressure of the hydrogen fueled electricity generator.

35. The method for operating the energy storage and recovery system of claim 29, wherein the hydrogen fueled electricity generator is adapted to be continuously pressurized by the hydrogen gas in fluid communication with the hydrogen storage device and the first and second pressure regulators.

36. A method for operating a regenerative electrochemical cell system, comprising:
introducing water and power to an electrolysis module to produce hydrogen and oxygen;
directing the hydrogen through a phase separation device and a dryer to a hydrogen storage device at a pressure, wherein the dryer removes water from the hydrogen to form a dry hydrogen;
hydrating the dry hydrogen by reducing the pressure of the dry hydrogen from the hydrogen storage device and, passing the dry hydrogen through the dryer thereby transferring water from the dryer to the dry hydrogen to form a hydrated hydrogen;
fueling a fuel cell by directing the hydrated hydrogen to the fuel cell module;
introducing oxygen to the fuel cell module; and
producing electricity and water at the fuel cell module.

37. A method for producing power, comprising:
generating power from a renewable power source;
conditioning the power for use in an electrochemical cell system;
maintaining water at a temperature above a freezing point of water;
forming hydrogen gas from the water using the conditioned power;
recovering water from an oxygen water stream;
venting oxygen to the environment;
drying the hydrogen gas;
compressing the hydrogen gas;
storing the hydrogen gas at a pressure of greater than or equal to about 1,000 psi;
monitoring availability of the renewable power source;
reducing the pressure of the hydrogen gas;
introducing at least a portion of the reduced pressure hydrogen gas to an internal combustion engine in response to the availability of the renewable power source being less than or equal to a first selected level;
generating power using the internal combustion engine;
introducing at least another portion of the hydrogen gas to a fuel cell in response to the availability of the renewable power source being less than or equal to a second selected level;
generating power using the fuel cell; and
operating power support systems using grid power.

38. The method for producing power of claim 37, wherein introducing at least another portion of the hydrogen gas to a fuel cell further comprises hydrating the hydrogen gas prior to entering the hydrogen gas into the fuel cell.

39. The method for producing power of claim 37, further comprising:
maintaining the fuel cell in a standby condition such that the fuel cell attains an operating temperature in less than or equal to about 1 minute.
